(19) United States
(12) Patent Application Publication
(10) Pub. No.: US 2004/0114351 A1
(43) Pub. Date: Jun. 17, 2004

(54) Flame simulation apparatus

(76) Inventors: Richard Stokes, Dorset (GB); Dominic Begley, Dorset (GB)

Correspondence Address: RICHARD M. GOLDBERG, 25 EAST SALEM SREEET, SUITE 419, HACKENSACK, NJ, 07601, US

(21) Appl. No.: 10/475,037

(22) PCT Filed: May 31, 2002
(86) PCT No.: PCT/GB02/02291

(30) Foreign Application Priority Data
Jun. 6, 2001 (GB) 0113729.8

(51) Int. Cl. F21V 33/00

(52) U.S. Cl. 362/96; 362/806; 362/811

(57) ABSTRACT

Apparatus for simulating flames and producing a more realistic flame effect is provided. The apparatus comprises a light source to illuminate at least one flame element which is movably suspended within the apparatus, and viewed through a diffusing screen. The apparatus includes a means for simulating airborne burning embers which comprises the tape used as the suspending means for the flame elements. The apparatus also includes reflective flicker flame elements to produce a variation in the colour and intensity of the flame effect produced. In has been found that the realism of the flame effect can be enhanced if the top of the flame element it is angled rearwards with respect to the viewing screen.

The present invention relates to apparatus for simulating flames, and in particular to apparatus for simulating and creating the impression of flames as would be produced by a solid fuel fire. Such apparatus in particular may be included in a heating device, for example an electric heater which, for aesthetic reasons, is desired to have the appearance of a real solid fuel fire.

Many arrangements exist and attempts have been made to simulate the appearance of flames produced by a real fire. One of the most common basic arrangements to create flame effects uses a combination of fabric or material ribbons located behind a diffusing translucent screen. The ribbons are illuminated by a lamp. A fan is provided to direct an air current over the material ribbons to cause them to move and flutter, thereby providing, when viewed through the diffusing screen, an impression of moving flames. To complete the effect of a solid fuel fire imitation fuel (coals or logs) are located in front of the screen and are similarly illuminated from beneath to simulate burning glowing fuel.

A number of prior patents disclose examples of, and minor variations, of the above described basic arrangement. Of the earliest of these are GB 978,365, GB 965,364, and GS 1,186,655 all of H. Frost & Company. Other more recent patents include GB 2,230,335; GB 2,302,730; GB 2,323,245; and GB 2,302,172.

The various arrangements described in the above patents, and prior arrangements currently being produced, provide with varying degrees of success an impression of flames. The realism of this effect can though be improved. In particular some of the prior arrangements can appear ‘flat’ with the flame effect appearing two dimensional. Also real flames are not generally of a single colour and include brighter highlights within their general orange appearance, and also real fires produce brighter sparks and airborne sparks from the embers. These effects are not produced by the prior arrangements, and it would be desirable to improve the realism if they were.

It is therefore desirable to provide an improved apparatus for simulating flames which provides a more realistic impression of real flames and/or which offers improvements generally.

According to the present invention there is provided an apparatus for simulating flames and producing a more realistic flame effect. In an embodiment, the apparatus comprises a light source, at least one flame element arranged to be illuminated by said light source and movably suspended within thin the apparatus, a diffusing screen disposed in front of said movable flame element and through which the at least one flame element may be viewed, and a means for moving the at least one flame element so that when illuminated by the light source the moving flame element provides the impression of a flame when viewed through the diffusing screen.

In accordance with one aspect of the invention the apparatus includes a means associated with the at least one flame element for simulating airborne burning embers. In one embodiment, this means comprises the suspending means for the flame elements. In a preferred embodiment the flame elements are suspended by means of a reflective tape which catches and reflects light from the light source. As this tape catches and reflects light from the light source as it twists and moves with the flame elements, it produces bright flashes of light and highlights above the viewed flame elements. These resemble airborne burning embers when viewed through the viewing screen.

In accordance with a second aspect: of the invention the apparatus includes means to produce in combination with the flame elements highlights in, and variation in the: colour and intensity of the flame effect produced. This again enhances the flame effect produced with the highlights adding variation and additional realism. Such highlights also enhance the impression of depth of the flames by adding accentuation to the viewed flame effect.

In an embodiment of the invention the apparatus further includes reflective “flicker flame” elements which are smaller than the flame elements and/or are more reflective than the flame elements. In an embodiment, these flicker flames are supported from their lower ends alone. This enables them to move more freely than the main flame elements. The flicker flame elements are to some degree self supporting.

In accordance with a further aspect of the invention the apparatus and movable flame elements arranged so as to provide an enhanced perception of depth and/or layered impression of the flame effect. In a particular embodiment of the invention the flame elements are suspended and secured within the apparatus such that the top of the flame element it is angled rearwards with respect to the viewing screen.

In this way, it has been found that movement of the flame elements in a forward and rearward direction is enhanced, with the rearward angling urging the flame elements to naturally fall rearwards under gravity and then be moved forward as they are caught in the air current produced by the fan which moves the elements. This also improves the impression of depth of flames.

In addition the rearward angling results in the air current from the fan impinging and catching the flame elements to a greater degree than if they were not inclined, such that the flame elements move to a greater degree. This improves the impression of depth and furthermore this creates a more realistic impression of dancing flames.

In an embodiment of the invention the depth of the flame effect produced is also enhanced by the use of the above mentioned flicker flame elements disposed behind the flame elements and spaced rearwards from them.

In accordance with a further aspect of the invention the apparatus comprises a plurality of flame elements. These flame elements are interconnected by a header strip which is secured to the apparatus to thereby secure the plurality of flame elements In this way the flame elements are secured in position in a simple and efficient manner, rather than the conventional arrangement in which the individual flame elements are individually secured.

Preferably, the header strip is secured to the apparatus at a fewer number of points than the number of flame elements such that the header strip and flame elements attached thereto billow away from the points at which the header strip is secured. As a result, the plurality of flame elements do not reside within the apparatus in the same plane. This, as with some of the previous aspects assists in creating an impression of flame depth.

The above described individual aspects of the invention all individually add to the realism of the effect produced and provide improvements to this type of apparatus. In addition when used in combination the resultant combined effect is greater than the sum of the individual elements and the combination of the, and/or some of the, individual aspects provides a yet further aspect and improvement in the art.

The present invention will now be described, by way of example only, with reference to the following illustrative drawings in which:

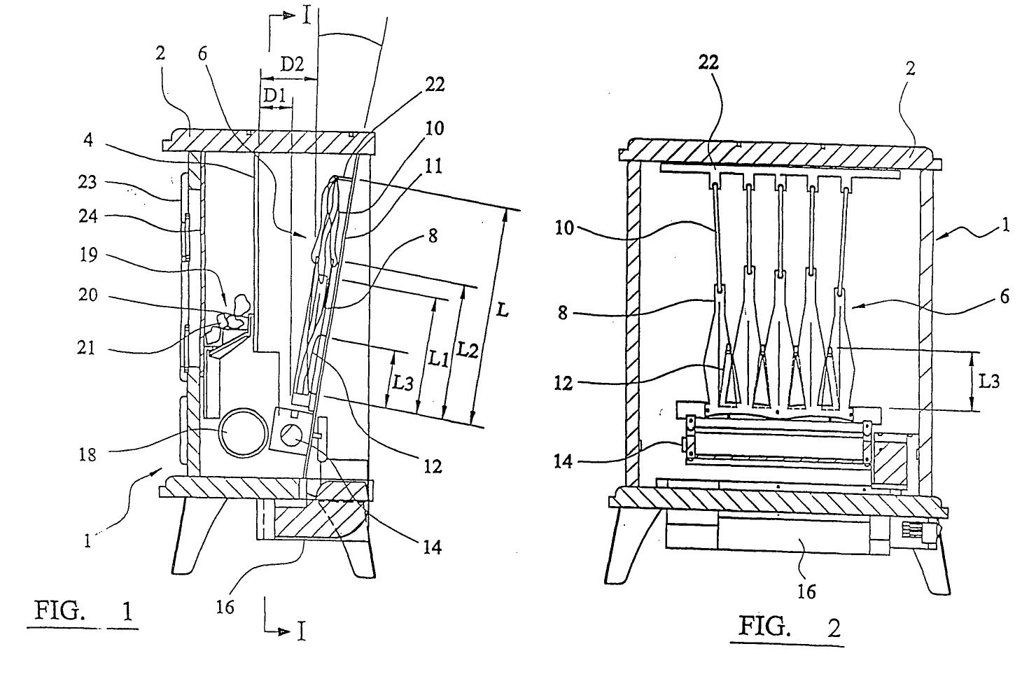

FIG. 1 is a side elevation cross section through, and of, a heating device including is apparatus for simulating flames in accordance with an embodiment of the present invention;

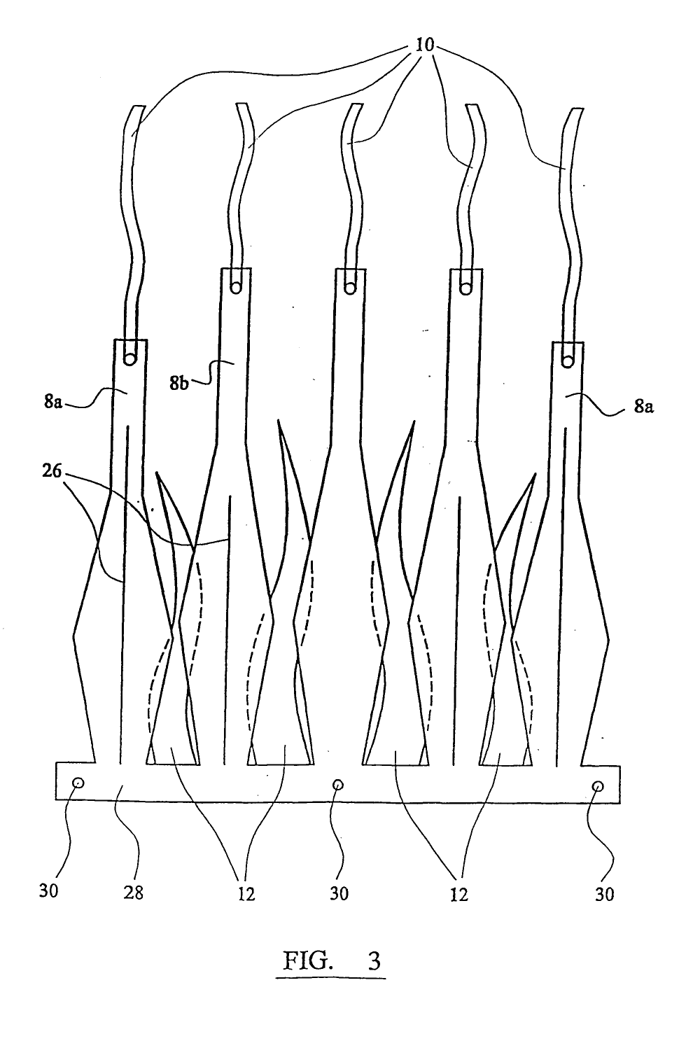

FIG. 2 is a front elevation section, along line I-I through and of the heating device shown in FIG. 2; and

FIG. 3 is a more detailed front view of the simulated flame effect means, in isolation, of the heating device shown in FIGS. 1 and 2.

Referring to the Figures, a heating device 1 resembling a solid fuel stove and including apparatus for simulating flames comprises a casing 2 which, in this particular example, has the external appearance of a solid fuel stove heater. The heating device 1 includes an electric convector fan heater 16 which provides the heating output of the heating device 1.

A glass window 24 is provided in the front of the casing 2 in order to view a simulated solid fuel bed 19 and simulated flame effect means 6 housed within the casing 2. The simulated fuel bed 19 comprises an angled plastic support 20 upon which synthetic coals 21 are supported. A light bulb 18 beneath the support illuminates the underside of the simulated fuel bed 19 such that in use the simulated fuel bed 19 appears to glow providing the impression of burning coals. Accordingly the light bulb and fuel bed arrangement is preferably arranged to provide a yellow/orange light. This can be achieved simply by using a suitably coloured translucent plastic to form the support 20, by using a suitably coloured light 18 or by interposing a coloured filter (not shown) between the light and support.

Behind the fuel bed 19 and supported within the casing 2 there is a transparent diffusing screen 4. The transparent diffusing screen 4 comprises a plastic screen which is frosted, by for example abrading lines onto the screen, by application of a frosted layer, or other suitable means, so as to have a matt surface and appearance and to diffuse light passing therethrough. Such diffusing screens are well known in the art and will therefore not in themselves be described further.

The simulated flame effect means 6 are disposed behind, and diffusely viewed through, this screen 4. The simulated flame effect means 6 comprises a series of simulated flame elements 8 which are loosely suspended and/or supported within the casing 2 from a rear support frame 11. The simulated flame elements 8 are, in use, also illuminated by the light 18.

A fan 14 within the casing 2 and disposed below the flame elements 8 in use directs an air current generally vertically upwards over the flame elements 8 causing the flame elements 8 to flutter and move.

When viewed through the diffusing screen 4 (Such that the flame effect means 6 are diffusely viewed) the moving and fluttering flame elements 8 provide the illusion of flames.

More specifically the simulated flame effect means 6 comprises a series of simulated flame elements 8 in the form of vertically extending shaped pieces 8a, 8b, or ribbons, of light weight fabric material. Suitable fabric materials for the flame elements 8 include satin nylon, silk or other similar materials, with the material preferably of a yellow, light red, or orange colour in order to resemble the colour of a flame.

The simulated flame elements 8a, 8b have a generally extended diamond shape with an extended upper section and as such generally resemble the shape of a flame. It will be appreciated that other shapes from the diamond shape shown can be used in other embodiments of the invention, and even simple strips have been found to be, at least partially, effective.

The flame elements 8 are of different lengths L1, L2 with the flame elements 8 disposed towards the lateral sides being shorter than those towards the centre. This corresponds to the larger flames that generally emanate from the centre of a real fire The individual flame elements 8a, 8b have a vertical slit 26 along the centre of the flame elements 8. This vertical slit enhances the twisting and movement of the flame elements enhancing realism of flame effect produced.

The top of each of the flame elements 8a, 8b is loosely suspended within the casing 2 by reflective tapes 10, comprising thin strips of, for example, aluminium foil. These tapes 10 extend from the tops of the flame elements 8a, 8b and are attached to an upper part of the support frame 11 with, when assembled, the flame elements 8 and reflective tapes 10 hanging loosely from the support frame 11. The reflective tapes 10 are, preferably, more reflective than the material flame elements 8. Accordingly as the flame elements 8 move and flutter the reflective support tapes 10 catch the light from the light bulb 18 and produce brighter flashes of reflected light which resemble the effect of airborne embers and highlights in the flames. This enhances and improves the realism of the flame effect produced.

The lower ends of the flame elements 8a, 8b are interconnected together by a common header strip 28 of material, with the flame elements 8 preferably produced and cut from a single piece of fabric material in order to reduce costs and improve the ease of mounting within the apparatus. The header strip 28 is attached and secured to the support frame 11 at a number of discrete points 30 along the length of the header strip 28. This secures and tethers the bottom of the flame elements 8.

It has been found that the flame effect is enhanced if the header strip is longer than the length of the support-frame 11/casing 2. In this, it may be attached fairly loosely along the support frame 11, rather than being taut. If the header strip 28 is relatively slack, the flame elements extending therefrom are loose and free from the support 11. As a result the portions in between the discrete attached points 30 advantageously can bow and billow away from the support 11. This bowing forward and billowing enhances the impression of depth of flames, with some of the flame elements 8 being further forward of other of the flame elements 8 and are able, in use, to move forward and backward from the support 11.

Behind the flame elements 8 and laterally spaced across the lower part of the support 11 are a series of additional flicker flame elements 12. These flicker flame elements 12 comprise small flame shape pieces of reflective material, for example aluminium foil, which are attached at their lower ends to the lower part of the support frame 11. The material for the flicker flame elements is also relatively stiff such that the flicker flame elements are to some degree self-supporting and can project vertically upwards.

As with the reflective support ribbons 10 the flicker flames 12 are more reflective than the flame elements 8. The length of the flicker flames 12 is less than the length L1, L2 of the flame elements 8a, 8b and the flicker elements 12 are preferably located laterally between adjacent flame elements 8.

In use the flicker flames 12 move in the air current from the fan and are also intermittently and partially obscured by the flame elements 8 disposed in front of them. The flicker flames as they intermittently catch and reflect the light from the light 18 produce bright highlights and flashes of light. These resemble the bright sparks and flashes produced in the lower portions of the flames of a solid fuel fire and further enhance the realism of the effect produced.

The support frame 11, and so flame elements 8 and flicker flames 12, is angled slightly rearwards as shown in FIG. 1, and preferably at an angle of between 9° and 10° to the vertical. In this way the lower end portion of the flame elements 8 are at a distance D1 from the screen 4, whilst the upper ends of the flame elements 8 are at a greater distance D2from the screen 4.

This, it has been unexpectedly found creates a more realistic effect in use of dancing flames and enhances the impression of depth of the flame effect produced.

It will also be appreciated that instead of a separate frame support 11, the flame elements 8 and flicker flames 12 could be supported directly from the casing 2 with such casing supports disposed so as to support the flame elements and flicker flames at the slight rearward angle.

1. Apparatus for simulating flames comprising a light source, at least one flame element arranged to be illuminated by said light source and movably suspended within the apparatus, a diffusing screen disposed in front of said movable flame element and through which the at least one flame element is diffusely viewed, and a means for moving the at least one flame element so that when illuminated by the light source the moving flame element provides the impression of a flame when viewed through the diffusing screen; wherein the flame element is suspended within the apparatus by a reflective tape which catches and reflects light from the light source.

2. Apparatus according to claim 1 wherein the at least one flame element is suspended and secured within the apparatus such that it is angled rearwards.

3. Apparatus according to claim 1 or claim 2 wherein the apparatus further comprises flicker flame elements which are smaller than the reflective flame elements which are more reflective than the flame elements and which are supported from their lower ends alone.

4. Apparatus for simulating flames comprising a light source, at least one flame element arranged to be illuminated by said light source and movably suspended within thin the apparatus, a diffusing screen disposed in front of said movable flame element and through which the at least one flame element is diffusely viewed, and a means for moving the at least one flame element so that when illuminated by the light source the moving flame element provides the impression of a flame when viewed through the diffusing screen; wherein the at least one flame element is suspended and secured within the apparatus such that it is angled rearwards.

5. Apparatus for simulating flames comprising a light source, at least one flame element arranged to be illuminated by said light source and movably suspended within thin the apparatus, a diffusing screen disposed in front of said movable flame element and through which the at least one flame element is diffusely viewed, and a means for moving the at least one flame element so that when illuminated by the light source the moving flame element provides the impression of a flame when viewed through the diffusing screen; the apparatus further including flicker flame elements which are smaller than the reflective flame elements which are more reflective than the flame elements and which are supported from their lower ends alone.

6. Apparatus according to any one of claims 3 to 5 wherein said flicker flames are supported from their lower ends.

7. Apparatus according to any one of the preceding claims wherein the depth of the flame effect is enhanced by the use of the flicker flame elements disposed behind the flame elements and spaced rearwards from them.

8. Apparatus according to any one of the preceding claims wherein the apparatus comprises a plurality of flame elements interconnected by a header strip which is secured to the apparatus.

9. Apparatus according to claim 8 wherein the header strip is secured to the apparatus at a fewer number of points than the number of flame elements.

10. Apparatus for simulating a flame effect substantially as herein described with reference to the accompanying drawings.
